(19) United States
(12) Patent Application Publication
(10) Pub. No.: US 2026/0246713 A1
(43) Pub. Date: Aug. 20, 2026

(54) ESTIMATING FUTURE NETWORK CELL LOAD WHILE PRESERVING USER EQUIPMENT PRIVACY

(71) Applicant: Telefonaktiebolaget LM Ericsson (publ), Stockholm (SE)

(72) Inventors: Hasan FAROOQ, Santa Clara, CA (US); Shruti BOTHE, Santa Clara, CA (US); Maxime BOUTON, Stockholm (SE); Julien FORGEAT, San Jose, CA (US); Nathali BARRERA, Palo Alto, CA (US)

(73) Assignee: Telefonaktiebolaget LM Ericsson (publ), Stockholm (SE)

(21) Appl. No.: 19/164,248

(22) PCT Filed: Mar. 15, 2023
(86) PCT No.: PCT/IB2023/052544

§ 371 Date: Sep. 11, 2025

(51) Int. Cl. H04L 41/16; H04W 4/02; H04W 24/08; H04W 64/00

(52) U.S. Cl. CPC H04L 41/16; H04W 4/025; H04W 24/08; H04W 64/00

(57) ABSTRACT

There is provided a method performed by a first user equipment (UE). The method comprises obtaining a machine learning (ML) model for predicting network usage for a UE, and receiving, from a network node, network configuration information indicating a network configuration of a first base station. The method further comprises generating trajectory data indicating a trajectory of the first UE's movement, and based on the trajectory data and the network configuration information, using the ML model, generating predicted network usage data indicating predicted network usage for the first UE. The method further comprises transmitting to the network node the predicted network usage data.

### TECHNICAL FIELD

This disclosure relates to estimating future network cell load while preserving user equipment (UE) privacy.

### BACKGROUND

To meet (i) user quality of experience (QoE) requirements, (ii) required and/or desired efficiency of network resource(s), and (iii) constraints on capital expenditures (CAPEX) and/or operating expenses (OPEX), self-organizing networks (SON) are emerging as an inevitable design feature for future mobile 6G networks. In SON, mobile networks are planned, configured, optimized, and healed in an efficient automated way.

The state-of-the-art SON functions for self-optimization and self-healing in 4G and 5G networks have generally a passive or a reactive line of action, as described in A. Imran, A. Zoha and A. Abu-Dayya, “Challenges in 5G: how to empower SON with big data for enabling 5G,” in IEEE Network, vol. 28, no. 6, pp. 27-33, November-December 2014, doi: 10.1109/MNET.2014.6963801. That is, by virtue of their design, SON functions kick in after some degradation has already occurred and thus, are only able to adapt to conditions many minutes after an event has happened. For example, a mobility load balancing SON function is triggered when a congestion is observed and/or diagnosed. After that, the SON function takes actions like changing some network parameter(s) until congestion is resolved. In another example, mobility robustness optimization is exploited by a SON function after hand-over (HO) drops below some threshold.

Some solutions such as the ones described in Ali et al., “6G white paper on machine learning in wireless communication networks,” 2020, arXiv:2004.13875. [Online]. Available: http://arxiv.org/abs/2004.13875, offer improvement(s) over fixed parameters settings in real networks. However, given the 6G network's target of creating perception of zero latency for latency aware applications like augmented reality (AR), virtual reality (VR), and/or extended reality (XR), this type of reactive SON may not be able to meet the performance requirements of Beyond 5G (B5G).

The reason is that in fast dynamical cellular environments where transmission and/or reception scheduling is done in order of milliseconds, some amount of time is needed by the SON algorithm to observe the situation, diagnose the problem, and then trigger the compensating action. Thus, by the time the realistic non-convex, non-deterministic polynomial-time (NP)-hard SON algorithms come up with optimal network configuration for the given environment, the environment might have already changed, and thus optimized parameter values determined by the SON algorithms may become outdated. This often means that changes are made to the network long after the need for such changes has passed, thereby creating a negative impact that reduces the gain that may be possibly achieved from using the SON algorithms. The resultant intrinsic delay on changing the network is not compatible with 6G network's targeted QoE levels.

Therefore, for 6G networks, the SON paradigm needs to be transformed from being reactive to being proactive, and this is possible only if, instead of waiting to observe and spot the problem, the problem can be predicted beforehand by empowering SON with machine learning (ML). This allows networks to predict future network states, thereby allowing to adapt to the demands in a smooth and controlled manner. For example, this transformation would result in shifting network coverage and capacity to zones where they are most needed before subscribers have been impacted by dropped calls or reduced data speeds.

One of the most important measures in estimating quality of service (QoS) of a future network state is estimated cell load utilization. The advantage of estimating cell load utilization is that many QoS-related key performance indicators (KPIs) are monotonic functions of average cell loads (e.g., average throughput, latency, and number of successful sessions, etc.), and thus by estimating future cell loads, other measures such as network wide user throughputs can be estimated as well.

The prediction of future network state (in terms of cell loads) can be done by inferring intelligence from network data which can be harnessed in mobile networks to predict the problem in its infancy, and then preemptive actions can be taken to resolve the problem before it occurs, thereby resulting in a proactive SON. However, there is one challenge that needs to be addressed—user privacy. As opposed to network-centric data like base-station (BS) performance management (PM) counters, UE-centric smartphone application data that contains sensitive information about the subscriber (e.g., such as position, orientation, smartphone sensor data, app usages, etc.) cannot be shared openly with the network operator.

One such example of privacy sensitive data is a subscriber's future network usage schedule. A UE can estimate its future location(s) and activity based on smartphone application activity. For example, when a subscriber uses a mapping or navigation application in his/her smartphone to find a route, the application knows the subscriber attributes such as a spatiotemporal location, a moving velocity and a landmark the subscriber is going to visit as long as the subscriber is following the suggested route. In this way, information about future trajectory of a UE can be exploited, for example, for handover optimization, load balancing, etc. Similarly, information in emails about meeting reminders in the subscriber's UE may provide an indication of where and how much network resources a subscriber is going to utilize in some future time. For example, an email application's meeting invite may have various information about the meeting such as how many participants will be in the meeting, whether the meeting will be a voice only meeting or a video meeting, a duration of the meeting, a location of the meeting, etc.

If the network can obtain this type of UE information for each UE (e.g., coordinates of estimated locations at which the UEs will be (or a nearby point of interest (POI)), the estimated timings of the UEs arriving at such locations, the minimum required rate and/or the minimum required QoE for the UEs), the availability of such information may offer the possibility to accurately predict future network load. Based on the predicted future network load, the network can take preemption actions such as traffic steering, proactive load balancing, running dynamic radio resource and energy efficiency algorithms, and intelligent caching as envisioned for 6G, as described in O. G. Aliu, A. Imran, M. A. Imran and B. Evans, “A Survey of Self Organisation in Future Cellular Networks,” in IEEE Communications Surveys & Tutorials, vol. 15, no. 1, pp. 336-361, First Quarter 2013, doi: 10.1109/SURV.2012.021312.00116.

### SUMMARY

Certain challenges presently exist. For example, most SON optimization solutions today have reactive line of actions (meaning that actions are taken after network problems have occurred, not before). But, as explained above, such reactive solutions may not address the network problems on time, thereby resulting in networks not being able to meet B5G QoE requirements.

As further explained above, recently, solutions based on proactive network optimization (in which actions are taken before network problems occur) have started to emerge. In such solutions, network optimization is performed based on future network state that is estimated based on historical network usage of UEs. The estimation of future network state based on historical network usage of UEs, however, is prone to error. For example, if a future state of a network is predicted based on historical network usage of UEs that are currently connected to the network, such prediction may not be accurate because, in the future, UEs (e.g., idle UEs) that were not connected to the network previously may become being connected to the network, thereby changing the network state. Thus, historical network usage of UEs alone is not enough for estimating the future network state. In order to solve this problem, future network state may be estimated based on predicted future network usage of UEs. But predicting future network usage of UEs may require UEs sharing privacy sensitive data (e.g., a location of a UE). Therefore, there is a need for a method, an apparatus, and/or a system for estimating future network state without compromising the privacy of UEs (i.e., without UEs sharing their privacy sensitive data).

Accordingly, in one aspect, there is provided a method performed by a first user equipment, UE. The method comprises obtaining a machine learning, ML, model for predicting network usage for a UE, and receiving, from a network node, network configuration information indicating a network configuration of a first base station. The method further comprises generating trajectory data indicating a trajectory of the first UE's movement, and based on the trajectory data and the network configuration information, using the ML model, generating predicted network usage data indicating predicted network usage for the first UE. The method further comprises transmitting to the network node the predicted network usage data.

In another aspect, there is provided a method performed by a first user equipment, UE. The method comprises obtaining a first machine learning, ML, model for generating encoded trajectory data associated with a trajectory of a UE's movement, and generating trajectory data indicating a trajectory of the first UE's movement. The method further comprises based on the trajectory data, using the first ML model, generating encoded trajectory data indicating the trajectory of the first UE's movement, and transmitting to a network node the encoded trajectory data for predicting network usage for the first UE.

In another aspect, there is provided a method performed by a network node. The method comprises receiving, from a first user equipment, UE included in a first group of UEs, first predicted network usage data that indicates predicted network usage for the first UE in the first group, and receiving, from a first UE included in a second group of UEs, first encoded trajectory data that indicates a trajectory of the first UE in the second group. The method further comprises, after receiving the first predicted network usage data and the first encoded trajectory data, generating combined predicted network usage data that indicates combined predicted network usage for the first group of UEs and the second group of UEs.

In another aspect, there is provided a first user equipment, UE. The first UE is configured to obtain a machine learning, ML, model for predicting network usage for a UE, and receive, from a network node, network configuration information indicating a network configuration of a first base station. The first UE is further configured to generate trajectory data indicating a trajectory of the first UE's movement, and based on the trajectory data and the network configuration information, using the ML model, generate predicted network usage data indicating predicted network usage for the first UE. The method further comprises transmitting to the network node the predicted network usage data.

In another aspect, there is provided a first user equipment, UE. The first UE is configured to obtain a first machine learning, ML, model for generating encoded trajectory data associated with a trajectory of a UE's movement, and generate trajectory data indicating a trajectory of the first UE's movement. The first UE is further configured to, based on the trajectory data, using the first ML model, generate encoded trajectory data indicating the trajectory of the first UE's movement, and transmit to a network node the encoded trajectory data for predicting network usage for the first UE.

In another aspect, there is provided a network node. The network node is configured to, receive, from a first user equipment, UE included in a first group of UEs, first predicted network usage data that indicates predicted network usage for the first UE in the first group, and receive, from a first UE included in a second group of UEs, first encoded trajectory data that indicates a trajectory of the first UE in the second group. The network node is further configured to, after receiving the first predicted network usage data and the first encoded trajectory data, generate combined predicted network usage data that indicates combined predicted network usage for the first group of UEs and the second group of UEs.

Some embodiments of this disclosure allow predicting future network loads (i.e., future network state) based on current information of network subscribers (UEs) while preserving UE privacy (i.e., without UEs sharing UE privacy sensitive data). This prediction is more accurate as compared to predicting future network state based on historical network usages of UEs, and works for both active and idle UEs.

### BRIEF DESCRIPTION OF THE DRAWINGS

The accompanying drawings, which are incorporated herein and form part of the specification, illustrate various embodiments.

FIG. 1 shows a system according to some embodiments.

FIG. 2 shows a process according to some embodiments.

FIG. 3A illustrates a machine learning model for predicting future network usage, according to some embodiments.

FIG. 3B shows an example of encoded trajectory data according to some embodiments.

FIG. 4 shows a process of creating a global machine learning model for encoding trajectory data according to some embodiments.

FIG. 5A shows an example of a Physical Resource Block (PRB) utilization matrix.

FIG. 5B shows an example of a PRB utilization matrix.

FIG. 5C shows an example of a PRB utilization matrix.

FIG. 5D shows an example of a PRB utilization matrix.

FIG. 5E shows an example of a PRB utilization matrix.

FIG. 5F shows a process according to some embodiments.

FIG. 6 shows a process according to some embodiments.

FIG. 7 shows a process according to some embodiments.

FIG. 8 shows a process according to some embodiments.

FIG. 9 shows an apparatus according to some embodiments.

FIG. 10 shows an apparatus according to some embodiments.

### DETAILED DESCRIPTION

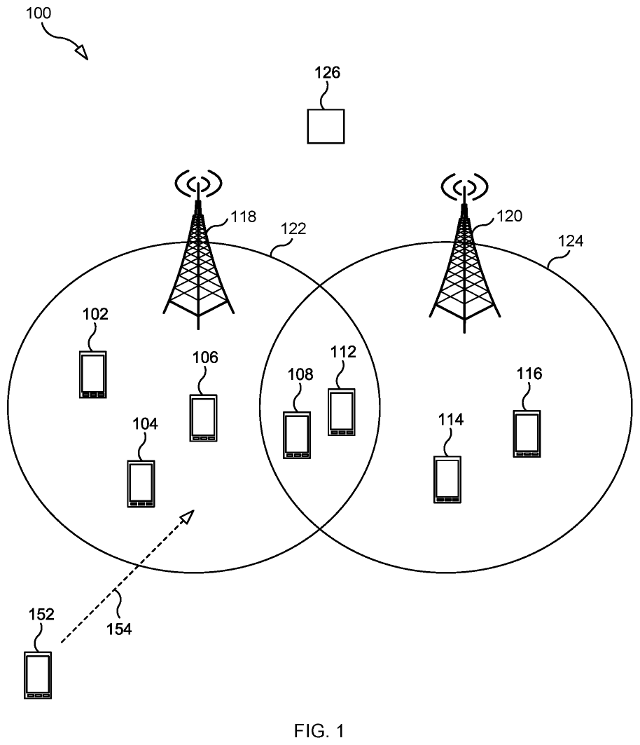

FIG. 1 shows a part of an exemplary system 100 according to some embodiments. The system 100 comprises UEs 102, 104, 106, 108, 112, 114, and 116, a first base station (e.g., eNB or gNB) 118, a second base station 120, and a controller 126. The first base station 118 is configured to provide a wireless network to the UEs 102-112, and the second base station 120 is configured to provide a wireless network to the UEs 114 and 116.

The wireless network provided by the first base station 118 is configured to cover a geographical region (a.k.a., “cell”) 122, and the wireless network provided by the second base station 120 is configured to cover a cell 124. Each of the UEs 102-116 is an electronic device capable of being wirelessly connected to the wireless networks provided by the first and second base station 118 and/or 120. Examples of the UEs 102-116 include a mobile phone, a tablet, a laptop, an Internet of Things (IoT) device, a desktop, a vehicle, a drone, etc. Note that the number of each of the entities (e.g., the UEs, the base stations, etc.) shown in FIG. 1 is provided for illustration purpose only, and do not limit the embodiments of this disclosure in any way.

The controller 126 is configured to change configuration(s) of the wireless networks provided by the first base station 118 and the second base station 120. For example, in case there is a network problem in the cell 122, the controller 126 may take action(s) (i.e., changing configuration(s) of the wireless network provided by the base station 118) to address the network problem. More specifically, in one example, in case the UE 102 is a critical UE, and the current download speed of the UE 102 in the cell 122 is below a threshold, the controller 126 may trigger a handover of the UEs 108 and 112 to the cell 124 such that the network load in the cell 122 is reduced, thereby increasing the download speed of the UE 102.

But, as explained above, by the time the controller 126 takes an action (e.g., triggering a handover of the UEs 108 and 112 to the cell 124) to address the network problem in the cell 122, the network state of the cell 122 may already have been changed, and thus the action may not be needed to address the network problem. Indeed, in some scenarios, the action may even cause another problem. For example, in the above exemplary scenario, by the time controller 126 triggers a handover of the UEs 108 and 112 to cell 124, the download speed of the UE 102 returns to an acceptable level but now a network congestion occurs in the cell 124. In this scenario, performing a handover of the UEs 108 and 112 from the cell 122 to the cell 124 only makes the network congestion in the cell 124 worse.

Therefore, it is desirable for the controller 126 to take action(s) (i.e., changing network configuration(s)) before network problem(s) actually occur (i.e., taking preemptive actions to prevent future potential network problems). Accordingly, in some embodiments, the controller 126 is configured to obtain information about predicted future network usage for the UEs 102-116 and change, based on the obtained information, configuration(s) of the wireless networks provided by the first base station 118 and/or the second base station 120, thereby performing network performance optimization for the cell 122 and/or 124. Note that, in this disclosure, predicted future network usage for UE(s) (or predicted future network usage associated with UE(s)) include predicted future network usage of the UE(s) for wirelessly transmitting data to the base station(s) and/or predicted future network usage of the base station(s) for wirelessly transmitting data to the UE(s).

The controller 126 can be configured to predict the future network usage for a UE based on UE related data (a.k.a., “UE private data”) using a machine learning (ML) model (e.g., a neural network). For example, in case a UE 152 shown in FIG. 1 is currently moving in a direction 154, and is currently streaming 1080p live video from a video application, such UE related data (i.e., the data indicating that the UE 152 is currently moving in the direction 154 and is currently streaming the 1080p live video) may be provided to the ML model, and the ML model may predict future network usage for the UE 152 in the cell 122. But, as explained above, because this UE related data may contain privacy sensitive information (e.g., the current location of the UE 152), it may not be desirable for the UE 152 to send this privacy sensitive information to controller 126.

Thus, according to some embodiments, instead of the UEs 102-116 sending UE private data, the UEs 102-116 either (i) predict future network usage for the UEs by themselves and send to the controller 126 predicted future network usage data indicating the predicted future network usage or (ii) encode UE private data, and send the encoded UE private data. In both cases, by not sending the raw UE private data, privacy of UEs can be protected.

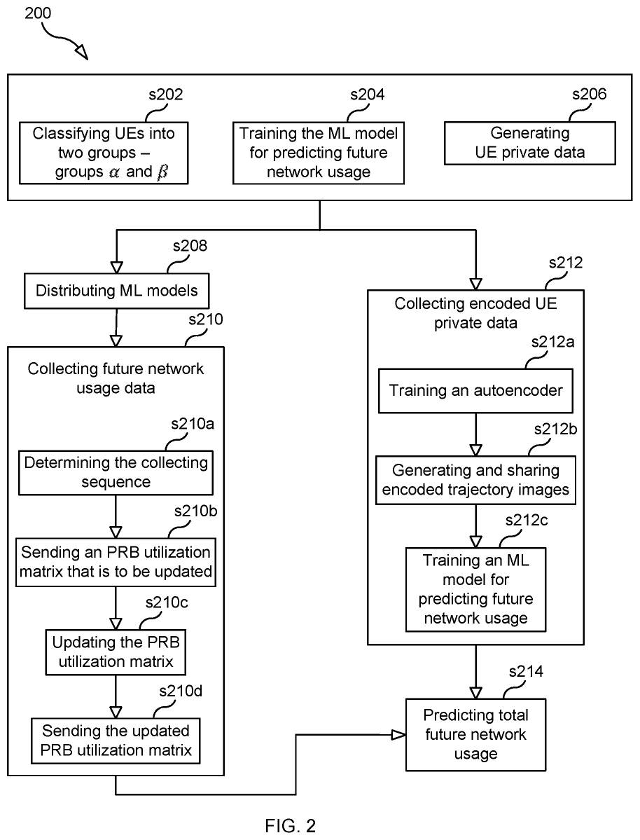

FIG. 2 shows a process 200 for predicting future network usage for the UEs 102-116 while preserving UE privacy, according to some embodiments.

Step s202—Classifying UEs

The process 200 may begin with step s202. Step s202 comprises classifying UEs into two groups—α and β groups. Depending on whether a UE is classified into the α group or the β group, the type of action(s) the UE takes during the process 200 is determined.

More specifically, in case a UE is classified into the α group, the UE may be configured to predict future network usage for the UE by itself and send information about the predicted future network usage to the controller 126. On the other hand, in case a UE is classified into the β group, the UE may be configured to encode UE private data which is required for predicting future network usage for the UE, and send the encoded UE private data to the controller 126 such that the controller 126 can predict future network usage for the UE using the UE private data.

In step s202, the controller 126 (or some other entity) may classify the UEs 102-116 into the α group or the β group, according to one or more factors. Examples of such factors include a trust level of a UE, a channel condition of a UE, on-device computation capability of a UE, historical data (e.g., whether a UE has always been a trusted device) and/or past behavior of a UE (e.g., past channel conditions (e.g., an average of certain number of last reported channel measurements performed by the UE), past cell associations (e.g., in which cell or which part of the network the UE has been residing most of the time, or how mobility active the UE has been)), etc.

The trust level may be determined based on the subscription level of a UE. For instance, if a UE has the highest subscription level (e.g., such as the “platinum subscription” in case there are bronze, gold, and platinum subscriptions), the trust level of this UE may be set to be the highest. Alternatively or additionally, the trust level of a UE may be determined based on whether the minimization of drive testing (MDT) feature is turned on for the UE. For example, UEs with the minimization of drive testing (MDT) feature turned on may be given the highest trust level.

The channel condition of a UE may be determined based on a measurement of signal(s) transmitted from a base station and received at the UE and/or a measurement of signal(s) transmitted from the UE and received at the base station. In one example, the channel condition of a UE may be classified into “good,” “ok,” and “bad” based on whether the measurement of the signal(s) is greater than or less than one or more threshold values.

The computational capability of a UE may be determined based on processing power of a central processing unit (CPU) of the UE and/or a graphics processing unit (GPU) of the UE. Like the channel condition, the computational capability of a UE may be classified into “good,” “ok,” and “bad” based on whether the computational capability is greater than or less than one or more threshold values.

There are many ways to use the factor(s) to classify the UE(s). For example, a classification score may be calculated based on a combination of the factor(s) for a UE (i.e., the classification score may be a function of the factor(s)) and the UE can be classified based on whether the UE's classification score is greater than or equal to a threshold value or is less than the threshold value. In one example, if the classification score of a UE is greater than or equal to a threshold value, the UE may be classified into the α group. On the other hand, if the classification score of the UE is less than the threshold value, the UE may be classified into the β group. There may be a scenario where a UE learns from its previous utilization and starts to predict more network usage than required or cheats the controller by “fake” booking resources on calendar invites, etc. In such scenario, upon detecting the UE's such misbehavior, the controller 126 may flag the UE and classify the UE into the β group.

As explained above, UEs (e.g., the UEs 102, 104, and 106) that belong to the α group are configured to generate the predicted future network usage data based on the UE private data by running an ML model at the UEs. On the contrary, UEs (e.g., the UEs 108 and 112) that belong to the β group are configured to generate encoded UE private data and send the encoded UE private data to controller 126. Here, the rationale is that the UEs belonging to the α group are trust-worthy to the controller 126, and thus the controller 126 can share its ML model which the UEs can use to generate the predicted future network usage data. On the contrary, the UEs belonging to the β group or the UEs that have been flagged by the controller 126 are the entities that the controller 126 is not confident in sharing the ML model, and thus those UEs send encrypted UE private data instead. In this disclosure, the ML model that the UEs can use to predict the future network usage for the UEs is also called a digital twin ML model.

### Function of the Digital Twin ML Model

As explained above, the UEs belonging to the α group (i.e., the UEs 102, 104, and 106) may use the ML model to predict the future network usage (i.e., usage of network resources) for the UEs based on UE private data. Here, the UE private data of a UE may include any one or more of: the location of the UE, the minimum required throughput for the UE, the configuration of the network provided to the UE, current Physical Resource Block (PRB) utilization of the UE, etc. The predicted future network usage may be indicated in the form of a PRB utilization matrix.

This PRB utilization matrix may comprise PRB utilization values indicating the amount of PRB usage for all base stations because of the UE's location and its interaction with its own serving cell. For example, in FIG. 1, assuming that the UE 102 is being served by the base station 118, the PRB utilization matrix for the UE 102 may comprise a first PRB usage value indicating the amount of PRB usage as a result of the UE 102 communicating with the base station 118 and a second PRB usage value indicating the amount of PRB usage of the base station 120 due to the UE 102 communicating with the base station 118. It is to be noted that increasing the PRB utilization in the serving cell can affect the PRB utilization in other cells, such as due to inter-cell interference from frequency reuse.

The following is the background information of PRBs. In the Long Term Evolution (LTE)/New Radio (NR), each base station has limited PRBs. Thus, when a UE needs to be served by a base station, the base station allocates some portions of the total PRBs to the UE based on the channel quality of the UE and a required uplink (UL)/downlink (DL) rate of the UE. The UL/DL PRB utilization is the ratio of PRBs occupied in a cell during a Transmission Time Interval (TTI) and total PRBs available in the cell. This information is available as a standard measurement from 3GPP as “UL/DL total PRB usage.” A loaded cell (i.e., the cell with traffic congestion) will have PRB utilization close to 1 and the loaded cell may start to block new incoming connections, thereby negatively impacting QoE.

Step s204—Training the Digital Twin ML Model

Referring back to FIG. 2, in step s204, the ML model may be trained at the controller 126 (or some other network node).

In training the ML model, simulated data (proprietary/open simulators) and/or real data may be used as training data. For example, the training data may be generated by (i) simulating a deployment in a network simulator, (ii) dropping a single test UE at various locations, and trying various network configurations and network loading levels, and (iii) determining the corresponding PRB utilization. In determining the PRB utilization, the following steps may be performed based on the UE and network topology/deployment:
calculating path loss of a UE (using realistic propagation model) and received power (using antenna patterns) for all base stations,
finding a serving cell of the UE,
calculating required PRBs for this UE (based on radio channel quality and scheduling algorithm used), and
updating PRB utilizations of the base stations (an increase in PRB utilization of one base station will affect PRB utilization of other cells due to inter-cell interference when using frequency 1 reuse).

Note that, in some embodiments, instead of using an ML model, a non-ML algorithm (e.g., if-else condition) may be used for predicting future network usage.

Step s206—Generating UE Private Data

In step s206, the UEs belonging to the α group and the β group may collect and/or generate UE private data. More specifically, the UEs (e.g., the UEs 102-116) may extract the UEs' plan of accessing the networks in the near future (i.e., may determine the UE's network usage behavior in the near future). A UE's plan of accessing the networks may be extracted using Application Programming Interfaces (APIs) provided by applications (e.g., meeting invites from an email application, meeting entries from a collaboration application, searched routes from a navigation application, posted events from a social networking application) installed at the UE and/or operating system of the UE.

More specifically, using the UE's access planning information (e.g., the information about a UE's travelling plan provided by a mapping or navigation application) provided by the applications and/or the operating system, the UE may generate spatial-temporal activity trajectory data S for the future time steps. The spatial-temporal activity trajectory data S may indicate estimated locations at which a UE will arrive at each future time slot, and how much data the UE is expected or required to use at each location. As shown in the table provided below, the spatial-temporal activity trajectory data S may be provided in the form of a matrix.

| | | The Minimum Required | |
|---|---|---|---|
| Time | Location | Rate (MRR) | |
| t1 | (x1, y1, z1) | 1 | Mbps |
| t2 | (x2, y2, z2) | 56 | kbps |

| | | |
|---|---|---|
| . . . | . . . | . . . |
| tk | (xk, yk, zk) | 0 |

Even though, in the table above, the location is expressed in terms of geographical coordinates, in other embodiments, the locations may be expressed using nearest points of interest (POIs). Also, in some embodiments, the MPRs can be replaced with 3GPP standardized QoS class identifier (QCI)/5G QoS identifier (5QI) values indicating a required or desired QoS for the UEs.

Step s208—Distributing ML Models

After performing steps s202-s206 (which can be performed in any order), step s208 may be performed for the UEs (e.g., the UEs 102, 104, and 106) in the α group. In step s208, the UEs in the α group may download the ML model trained in step s204 from the controller 126 or may update the existing ML model that the UEs had based on update information received from the controller 126. The updated information may be related to the model parameters of the ML model trained in step s204.

Initially, the UEs may download the initial ML model from the controller 126. After downloading the initial ML model, the UEs may determine (periodically or upon an occurrence of a certain condition) whether the UEs need to download a new ML model or update the existing ML model that the UEs have. Depending on the determination, the UEs may continue to use the existing ML model, download a new ML model, or update the existing ML model.

Step s210—Collecting Predicted Future Network Usage Data

After obtaining the ML model, in step s210, the UEs in the α group (e.g., the UEs, 102, 104, and 106) may generate predicted future network usage data for the UEs based on the UE private data using the ML model. For example, each of the UEs 102, 104, and 106 may provide the spatial-temporal activity trajectory data S that each UE obtained in step s206 to the ML model, thereby generating the predicted future network usage data. Then, each of the UEs 102, 104, and 106 may transmit the predicted future network usage data to the controller 126.

As discussed above, in some embodiments, the predicted future network usage data may be provided in the form of a PRB utilization matrix (the shaded portion in the table below).

For example, in case the controller 126 manages only two base stations (BSs)—118 and 120, the PRB utilization matrix generated by the UE 102 may be:

In some embodiments, the controller 126 may collect the predicted future network usage data from the UEs in the α group (e.g., the UEs 102, 104, and 106) in a certain sequence (e.g., collecting from the UE 102 first, then from the UE 104, and finally from the UE 106). The collecting sequence may be determined by the controller 126.

Step 210a—Determining the Sequence of Collecting Predicted Future Network Usage Data

In order to determine the collecting sequence, in step s210a, the controller 126 may first identify the UEs belonging to the α group, and then sort them based on one or more criteria, thereby determining the collecting sequence (i.e., the sorted sequence). Examples of such criteria include energy consumption of a UE, a load level of a UE, channel conditions of a UE, a subscription level of a UE, etc.

Step 210b—Sending the PRB Utilization Matrix (P₀) to be Updated

Once the collecting sequence is determined, in step s210b, the controller 126 may send to the first UE in the sequence (e.g., the UE 102) the data structure of predicted future network usage data that the first UE needs to report to the controller 126. One example of the data structure of predicted future network usage data is an initialized PRB utilization matrix.

The table provided below shows an example of the initialized PRB utilization matrix (the shaded portion) according to some embodiments.

As shown above, the initialized PRB utilization matrix includes k rows and n columns. Here, k corresponds to a number of time slots for which future network usage predictions are made and n corresponds to a number of base stations associated with the future network usage predictions.

For example, all corresponds to a PRB utilization value indicating the amount of PRB usage that is predicted to be used in the base station 1 for a UE when communicating with its serving base station during the time interval t1. Similarly, a21 is a PRB utilization value indicating the amount of PRB usage that is predicted to be used in the base station 1 for a UE when communicating with its serving base station during the time interval t2. Because the PRB utilization matrix shown above is the initialized matrix, all the PRB utilization values included in the matrix is zero.

The initialized PRB utilization matrix may be expressed as

$${P}_{0} = [ {P}_{0}^{t 1} ; {P}_{0}^{t 2} ; … ; {P}_{0}^{t k} ] where {P}_{0}^{t 1}$$

is an initialized PRB utilization vector for the interval t1,

$${P}_{0}^{t 2}$$

is an initialized PRB utilization vector for the interval t2, and

$${P}_{0}^{t k}$$

is an initialized PRB utilization vector for the interval tk. Please note that the data structure of predicted future network usage data is not limited to a matrix but can be any data structure format. Also, the predicted network usage can be indicated using something other than PRB utilization values.

In step s210b, in addition to sending the initialized PRB matrix, the controller 126 may also send to the first UE in the collecting sequence (e.g., the UE 102) network configuration information indicating current and/or future configurations of wireless networks managed by the controller 126. Examples of the network configuration information include antenna tilting value of a base station, transmission power of a base station, etc.

Step 210c—Updating the Received PRB Utilization Matrix

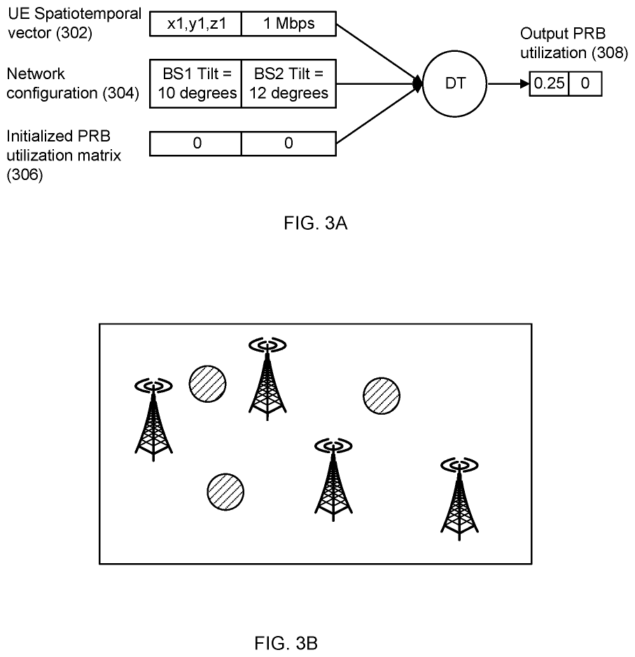

In step s210c, using the ML model, the first UE in the collecting sequence may predict future network usage for the first UE based on three types of input data 302, 304, and 306 shown in FIG. 3A.

The first input data 302 corresponds to UE private data available at the first UE. As discussed above, one example of the UE private data is the first UE's spatiotemporal activity trajectory data (e.g., the first UE's spatiotemporal activity trajectory matrix Si).

The second input data 304 corresponds to the network configuration information that the first UE received from the controller 126. The network configuration information may indicate current and/or future configurations of the networks managed by the controller 126.

The third input data 306 corresponds to the initialized PRB utilization matrix.

As shown in FIG. 3A, the three types of input data 302, 304, and 306 are provided to the ML model, and based on the three types of input data 302-306, the ML model is configured to generate output data 308. Here, the output data 308 corresponds to the predicted future network usage data. An example of the output data 308 is the updated PRB utilization matrix (P₁) as illustrated in the table below.

More specifically, the output data 308 may indicate the amount of PRB resources that are predicted to be used for communication between the first UE and its serving base station during k time slots, and such communication's effect on the PRB utilization on other n−1 base stations. As explained above, each value included in the table above may correspond to the ratio of PRBs occupied in a cell during a Transmission Time Interval (TTI) with respect to total PRBs available in the cell.

Step 210d—Sending the Updated PRB Utilization Matrix

After generating the predicted future network usage data (e.g., the updated PRB utilization matrix), in step s210c, the first UE may send the predicted future network usage data to the controller 126. More specifically, in one example, the first UE may send the updated PRB utilization matrix (P₁) to the controller 126 in step s210d.

As explained above, the steps 210b-210d are initially performed for the first UE in the collecting sequence. However, in some embodiments, the steps 210b-210d are repeatedly performed for each of all the UEs in the collecting sequence.

More specifically, after the controller 126 receives the updated PRB utilization matrix from the first UE in the collecting sequence (in the step 210d for the first UE), the controller 126 may send to the second UE in the collecting sequence (1) the updated PRB utilization matrix and (2) network configuration information indicating present and/or future configurations of the wireless networks managed by the controller 126 (in the step 210b for the second UE). This network configuration information may be same as or different from the network configuration information that the controller 126 sent to the first UE in the collecting sequence.

Then, in step 210c for the second UE, the second UE may generate further updated PRB utilization matrix (P₂), and in step 210d for the second UE, the second UE may send the further updated PRB utilization matrix (P₂) to the controller 126.

The steps 210b-210d are repeatedly performed for all UEs in the α group. After these steps, the controller 126 would receive the updated PRB utilization matrix from the last UE in the collecting sequence.

In a summary, through steps 210b-210d, each of the UEs in the α group sends to the controller 126 the predicted future network usage for the UE, thereby allowing the controller 126 to determine a total predicted future network usage for the UEs in the α group.

Step s212—Collecting Encoded UE Private Data

As explained above, because the UEs in the α group are trustworthy to the controller 126, it is okay for the controller 126 to share with the UEs the ML model. But the UEs in the β group are not trustworthy. Thus, it is not desirable for the controller 126 to share the ML model with those UEs. Because the UEs in the β group do not have the ML model for predicting future network usage, these UEs cannot predict future network usage for the UEs. Therefore, the controller 126 cannot collect predicted future network usage data from these UEs as in step s210.

Accordingly, instead of collecting predicted future network usage data from the UEs in the β group, in step s212, the controller 126 may collect encoded UE private data from the UEs in the β group. There are different ways of encoding UE private data of the UEs in the β group. One of the ways is using an encoder of an autoencoder.

As explained in step s206, all UEs may obtain UE private data. One example of the UE private data is spatial-temporal activity trajectory data S. As shown below, the trajectory data S may indicate a predicted location of a UE at a specific time slot and the amount of network usage (e.g., the MRR) at the predicted location at the specific time slot.

| | | The Minimum Required | |
|---|---|---|---|
| Time | Location | Rate (MRR) | |
| t1 | (x1, y1, z1) | 1 | Mbps |
| t2 | (x2, y2, z2) | 56 | kbps |

| | | |
|---|---|---|
| . . . | . . . | . . . |
| tk | (xk, yk, zk) | 0 |

To encode this UE private data, the UEs in the β group may first convert the trajectory data S into image data I. FIG. 3B shows an example of the image data I.

As shown in FIG. 3B, the image data I may include a plurality of circles each of which indicates a predicted location of a UE at a specific time slot, and the pattern of each circle may indicate the MRR at the predicted location. Note that the predicted locations and the MRRs can be included in the image data I in any format and in any way.

After converting the trajectory data S into image data I, the UEs in the β group may use an encoder of an autoencoder to encode the image data I, thereby generating encoded image data I′ (corresponding to the encoded image data).

Step s212a—Training an Autoencoder

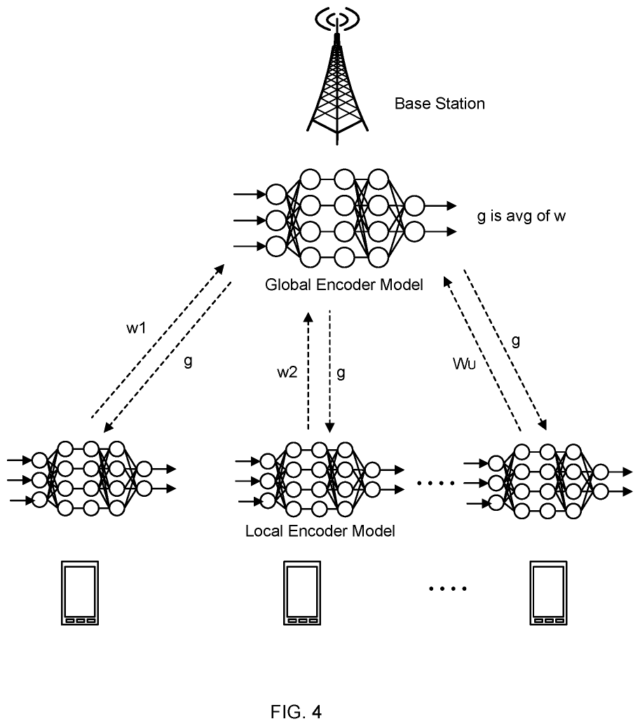

To use an encoder of an autoencoder for encoding the image data I, the autoencoder needs to be trained first. Thus, in step s212a, each of the UEs in the β group may train its autoencoder with randomly generated images or image data corresponding to the previous trajectory data. After training the autoencoder, each of the UEs in the β group may share the model parameters of the encoder of the trained autoencoder with the controller 126. For example, in case the encoder of the autoencoder comprises layers of neural network (NN), each of the UEs in the β group may send to the controller 126 weight values (w₁, w₂, w₃, . . . wₘ) of the NN layers corresponding to the encoder, as shown in FIG. 4, where m corresponds to the number of UEs in the β group.

After receiving the weight values of the encoder of the autoencoders trained at the UEs in the β group, the controller 126 may combine them using a function F, thereby generating a global encoder E. In one example, the controller 126 may average the weight values, thereby obtaining averaged weight values, and use the averaged weight values as the weight values of the global encoder E. After generating the global encoder E, the controller 126 may send the model parameters of the global encoder E to the UEs in the β group.

Step s212b—Generating and Sharing Encoded Trajectory Images

After receiving the model parameters of the global encoder, each UE in the β group may convert the spatial-temporal activity trajectory data S into image data I, and use the global encoder to encode the image data I, thereby generating encoded image data I′. Then, each UE in the β group may transmit to the controller 126 the encoded image data I′ (corresponding to the encoded UE private data).

Sten s212c—Training an ML model for Predicting Future Network Usage

Because the controller 126 receives from the UEs in the β group encoded UE private data (e.g., the encoded image data I′), not the predicted network usage data, the controller 126 needs to generate predicted network usage data based on the encoded UE private data. Thus, in some embodiments, the controller 126 may use an ML model. The ML model may generate the predicted network usage data based on (1) the encoded UE private data (e.g., the encoded image data I′), (2) the current and/or future network configuration of the wireless networks associated with the controller 126, and (3) the current PRB utilization matrix (dimension dependent upon window size of k time slots). More detailed explanation as to how the ML model generates the predicted network usage data is described below with respect to step s214.

In order to train this ML model, the controller 126 may first generate various spatiotemporal trajectories encoded with global encoder E and using the digital twin ML model to generate the corresponding labels which will constitute the training dataset for this encoded PRB prediction model.

Step s214—Predicting Total Future Network Usage

As explained above with respect to step s210d, the last UE in the sorted α group may send to the controller 126 the updated PRB utilization matrix. This updated PRB utilization matrix indicates total predicted future network usage for the UEs in the α group.

In step s214, this PRB utilization matrix may be further updated to indicate predicted future network usages for the UEs in the β group as well as the UEs in the α group. More specifically, the controller 126 may sort the UEs in the β group in a certain sequence, and generate updated PRB utilization matrix based on (1) the encoded image data I′ that the controller 126 received from the first UE in the sorted β group, (2) the current and/or future network configuration, and (3) the PRB utilization matrix that the controller 126 received from the last UE in the α group.

Then, the controller 126 may generate a further updated PRB utilization matrix based on (1) the encoded image data I′ that the controller 126 received from the second UE in the sorted β group, (2) the current and/or future network configuration, and (3) the PRB utilization matrix that the controller 126 generated from the first UE in the sorted β group. This process may be repeated for all UEs in the β group. Thus, in the last step, the controller 126 may generate a final updated PRB utilization matrix based on (1) the encoded image data I′ that the controller 126 received from the last UE in the sorted β group, (2) the current and/or future network configuration, and (3) the PRB utilization matrix that the controller 126 generated from the second last UE in the sorted β group.

The final updated PRB utilization matrix corresponds to the total future network usage data.

Once the controller 126 obtains the final updated PRB utilization matrix (i.e., total predicted future network usage for the UEs in the α group and the β group, the controller 126 may use this information to perform network optimization (e.g., proactive load balancing, energy saving, capacity optimization, mobility robustness optimization, etc.).

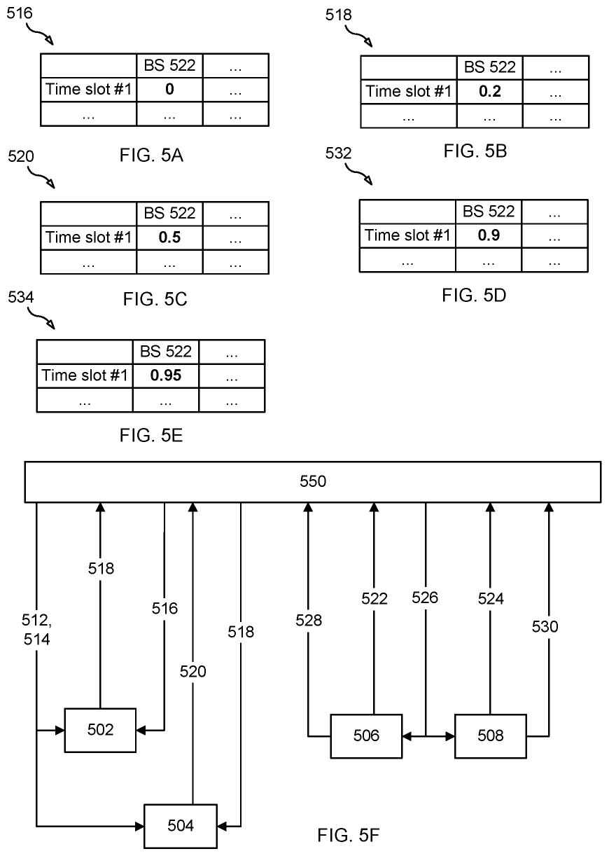

FIG. 5F shows an exemplary scenario where the process 200 is applied. In FIG. 5F, there are two UEs in the α group—UEs 502 and 504, and there are two UEs in the β group—UEs 506 and 508. In the α group, UEs 502 and 504 are sorted by a controller 550 in a sequence of UE 502 and the UE 504. Similarly, in the β group, UEs 506 and 508 are sorted by the controller 550 in a sequence of the UE 506 and the UE 508.

### The α Group

In the exemplary scenario, the controller 550 distributes to UEs 502 and 504 an ML model 512 for predicting future network usage for a UE (e.g., the ML model for updating the PRB utilization matrix). Also, the controller 550 distributes to UEs 502 and 504 network configuration information 514 indicating present and/or future network configurations of networks controlled by the controller 550. Furthermore, since the UE 502 is the first UE in the α group, the controller 550 sends to UE 502 an initial PRB utilization matrix 516.

Based on the received initial PRB utilization matrix 516 and the received network configuration information 514, the UE 502 generates an updated PRB utilization matrix 518 using the ML model 512. As shown in FIGS. 5A and 5B, as compared to the initial PRB utilization matrix 516, in the updated PRB utilization matrix 518, an PRB utilization value corresponding to a base station 522 has been changed from zero to 0.2. The value 0.2 indicates an amount of network usage that is predicted to be used in the base station 522 due to communications between the UE 502 and its serving base station. The UE 502 sends the updated PRB utilization matrix 518 to the controller 550.

Upon receiving the updated PRB utilization matrix 518, the controller 550 sends to the next UE in the sorted α group (i.e., the UE 504) the updated PRB utilization matrix 518. Based on the received updated PRB utilization matrix 518 and the received network configuration information 514, the UE 504 generates a further updated PRB utilization matrix 520 using the ML model 512. As shown in FIGS. 5B and 5C, as compared to the updated PRB utilization matrix 518, in the further updated PRB utilization matrix 520, an PRB utilization value corresponding to the base station 522 has been changed from 0.2 to 0.5 (0.2+0.3). Here, the value 0.3 indicates an amount of network usage that is predicted to be used in the base station 522 due to communications between the UE 504 and its serving base station. The UE 504 sends the updated PRB utilization matrix 520 to the controller 550.

### β Group

Each UE included in the β group trains an encoding ML model for encoding trajectory data related to a trajectory of a UE. More specifically, the UE 506 trains an ML model for encoding trajectory data related to a trajectory of the UE 506's movement, and the UE 508 trains an ML model for encoding trajectory data related to a trajectory of the UE 508's movement. The trajectory data may indicate a plurality of time slots, a location of a UE at each time slot, and desired/required network usage at each location. Once the UEs 506 and 508 train their ML models, they send to the controller 550 the trained ML models 522 and 524, respectively.

Upon receiving the trained ML models 522 and 524, the controller 550 combines the received training ML models 522 and 524, thereby generating a global ML model 526. Then the controller 550 distributes the global ML model 526 to the UE 506 and the UE 508.

Then the UE 506 encodes trajectory data related to a trajectory of the UE 506's movement, thereby generating encoded trajectory data 528, and sends the encoded trajectory data 528 to the controller 550. Similarly, the UE 508 encodes trajectory data related to a trajectory of the UE 508's movement, thereby generating encoded trajectory data 530, and sends the encoded trajectory data 530 to the controller 550.

After receiving the encoded trajectory data 528 and 530 from the UEs 506 and 508, the controller 550 generates predicted network usage data (e.g., updated PRB utilization matrix) for the UE 506 first because the UE 506 is the first UE in the sorted β group. More specifically, based on the encoded trajectory data 528 it received from the UE 506, network configuration information of the controller 550, and the PRB utilization matrix 520 received from the UE 504, the controller 550 generates updated PRB utilization matrix 532 (shown in FIG. 5D) using a network usage prediction ML model.

As shown in FIGS. 5C and 5D, as compared to the updated PRB utilization matrix 520, in the updated PRB utilization matrix 532, an PRB utilization value corresponding to the base station 522 has been changed from 0.5 to 0.9 (0.5+0.4). Here, the additional value 0.4 indicates an amount of network usage that is predicted to be used in the base station 522 due to communications between the UE 506 and its serving base station.

Then, the controller 550 generates predicted network usage data (e.g., updated PRB utilization matrix) for the UE 508 because the UE 508 is the second UE in the sorted β group. More specifically, based on the encoded trajectory data 530 it received from the UE 508, network configuration information of the controller 550, and the updated PRB utilization matrix 532, the controller 550 generates further updated PRB utilization matrix 534 (shown in FIG. 5E) using the network usage prediction ML model.

As shown in FIGS. 5D and 5E, as compared to the updated PRB utilization matrix 532, in the further updated PRB utilization matrix 534, an PRB utilization value corresponding to the base station 522 has been changed from 0.9 to 0.95 (0.9+0.05). Here, the additional value 0.05 indicates an amount of network usage that is predicted to be used in the base station 522 due to communications between the UE 508 and its serving base station. Here, the last updated PRB utilization matrix 534 indicates a total network usage for the UEs 502, 504, 506, and 508.

In the exemplary scenario described above, the future network usage for the UEs in the β group is predicted after the future network usage for the UEs in the α group. However, in another scenario, the future network usage for the UEs in the α group is predicted after the future network usage for UEs in the β group. In such scenario, instead of generating the updated PRB utilization matrix 532 based on the PRB utilization matrix 520 that the controller 550 received from the UE 504, the controller 550 generates the updated PRB utilization matrix 532 based on the initialized PRB utilization matrix 516. Furthermore, in such scenario, instead of generating the updated PRB utilization matrix 518 based on the initial PRB utilization matrix 516, the UE 502 generates the updated PRB utilization matrix 518 based on the updated PRB utilization matrix 534 generated for the UE 508 in the β group.

In another exemplary scenario, the future network usage for the UEs in the β group and the future network usage for the UEs in the α group may be generated independently (and in parallel). In such scenario, instead of generating the updated PRB utilization matrix 532 based on the PRB utilization matrix 520 that the controller 550 received from the UE 504, the controller 550 generates the updated PRB utilization matrix 532 based on the initialized PRB utilization matrix 516. Once the controller 550 obtains the updated PRB utilization matrix 520 for the α group and the updated PRB utilization matrix 534 for the β group, the controller 550 may combine them together in order to obtain the combined PRB utilization matrix that indicates the total predicted network usage for the UEs 502, 504, 506, and 508.

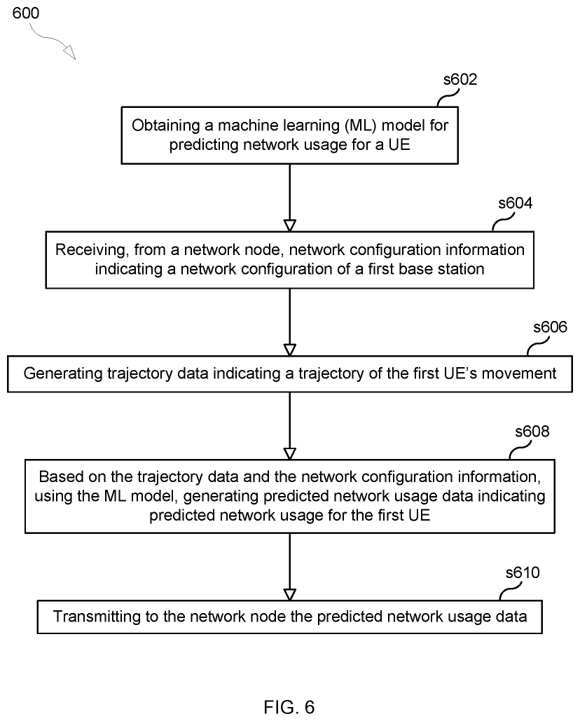

FIG. 6 shows a process 600 performed by a first user equipment (e.g., the UE 102, 104, or 106). The process 600 may begin with step s602. The step s602 comprises obtaining a machine learning, ML, model for predicting network usage for a UE. Step s604 comprises receiving, from a network node, network configuration information indicating a network configuration of a first base station. Step s606 comprises generating trajectory data indicating a trajectory of the first UE's movement. Step s608 comprises, based on the trajectory data and the network configuration information, using the ML model, generating predicted network usage data indicating predicted network usage for the first UE. Step s610 comprises transmitting to the network node the predicted network usage data.

In some embodiments, the predicted network usage for the first UE is predicted usage of physical resource blocks, PRBs, in a plurality of base stations due to communications between the first UE and the first UE's serving base station.

In some embodiments, the ML model is configured to predict network usage for a UE based on any one or more of: a location of a UE, a minimum required throughput of a UE, a quality of service, QoS, required for a UE, a network configuration of a base station, and/or a current PRB utilization of a base station.

In some embodiments, the trajectory data indicates a minimum required throughput of the first UE and/or a QoS required for the first UE, and the minimum required throughput of the first UE and/or the QoS required for the first UE is associated with a certain geographical location within the trajectory of the first UE's movement.

In some embodiments, a plurality of UEs connected to the network node are classified into a first group of one or more UEs and a second group of one or more UEs, the classification of a UE is based on any one or more of: a trust level of a UE, a channel condition of a UE, computational capability of a UE, historical data associated with a UE, or a past behavior of a UE, only UEs included in the first group of UEs are allowed to receive from the network node ML model information indicating the ML model, and the first UE belongs to the first group of UEs.

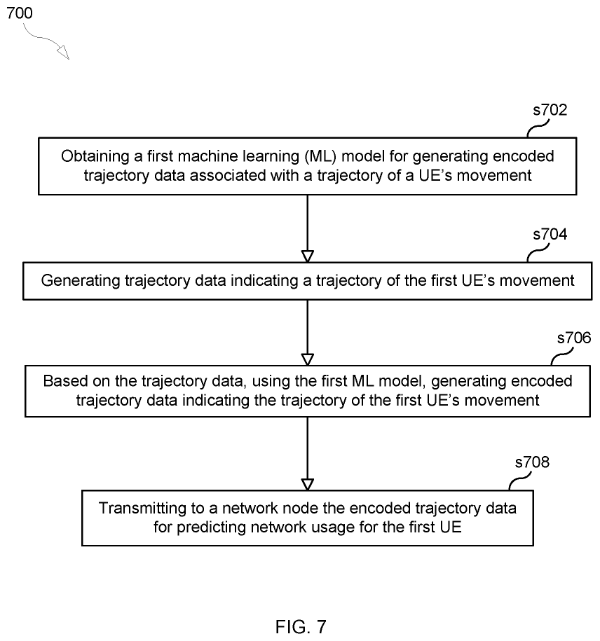

FIG. 7 shows a process 700 performed by a first UE (e.g., the UE 108 or 112). The process 700 may begin with step s702. The step s702 comprise obtaining a first machine learning, ML, model for generating encoded trajectory data associated with a trajectory of a UE's movement. Step s704 comprises generating trajectory data indicating a trajectory of the first UE's movement. Step s706 comprises, based on the trajectory data, using the first ML model, generating encoded trajectory data indicating the trajectory of the first UE's movement. Step s708 comprises transmitting to a network node the encoded trajectory data for predicting network usage for the first UE.

In some embodiments, predicted network usage for the first UE is predicted usage of physical resource blocks, PRBs, in a plurality of base stations due to communications between the first UE and the first UE's serving base station.

In some embodiments, the trajectory data indicates a minimum required throughput of the first UE and/or a quality of service, QoS, required for the first UE, and the minimum required throughput of the first UE and/or the QoS required for the first UE is associated with a certain geographical location within the trajectory of the first UE's movement.

In some embodiments, the process 700 comprises training an initial ML model for generating encoded trajectory data associated with a trajectory of a UE's movement; transmitting to the network node the trained initial ML model; and receiving from the network node a global ML model that is generated based on the trained initial ML model, wherein the first ML model is the global ML model.

In some embodiments, a plurality of UEs connected to the network node are classified into a first group of one or more UEs and a second group of one or more UEs, the classification of a UE is based on any one or more of: a trust level of a UE, a channel condition of a UE, computational capability of a UE, historical data associated with a UE, or a past behavior of a UE, only UEs included in the second group of UEs are allowed to receive from the network node ML model information indicating the global ML model, and the first UE belongs to the second group of UEs.

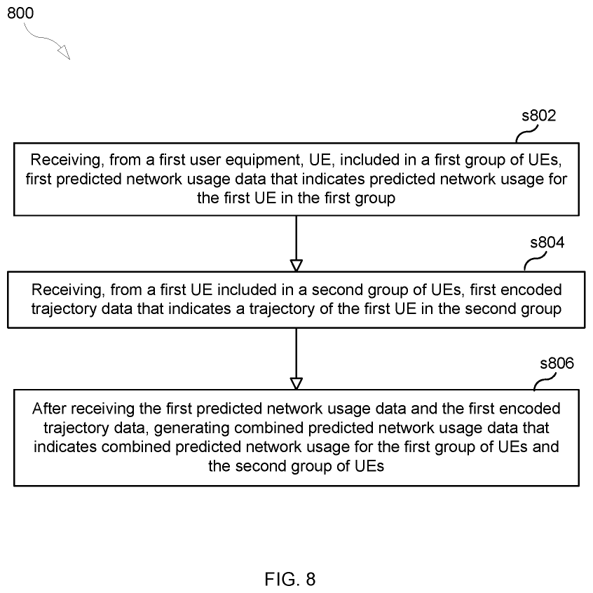

FIG. 8 shows a process 800 performed by a network node (e.g., the controller 126). The process 800 may begin with step s802. The step s802 comprises receiving, from a first user equipment, UE, included in a first group of UEs, first predicted network usage data that indicates predicted network usage for the first UE in the first group. Step s804 comprises receiving, from a first UE included in a second group of UEs, first encoded trajectory data that indicates a trajectory of the first UE in the second group. Step s806 comprises, after receiving the first predicted network usage data and the first encoded trajectory data, generating combined predicted network usage data that indicates combined predicted network usage for the first group of UEs and the second group of UEs.

In some embodiments, UEs are classified into the first group of UEs or the second group of UEs based on any one or more of: a trust level of a UE, a channel condition of a UE, computational capability of a UE, historical data associated with a UE, or a past behavior of a UE.

In some embodiments, the predicted network usage for the first UE in the first group is predicted usage of physical resource blocks, PRBs, in a plurality of base stations due to communications between the first UE in the first group and the first UE's serving base station.

In some embodiments, the process 800 comprises transmitting, only to the first group of UEs, first ML model information indicating a first ML model for predicting network usage for a UE, wherein the first predicted network usage data is generated using the first ML model.

In some embodiments, the first ML model is configured to predict network usage for a UE based on any one or more of: a location of a UE, a minimum required throughput of a UE, a quality of service, QoS, required for a UE, a network configuration of a base station, and/or a current physical resource block, PRB, utilization of a base station.

In some embodiments, the process 800 comprises transmitting, to the first group of UEs, network configuration information indicating a network configuration of one or more base stations associated with the network node, wherein the first predicted network usage data is generated using the first ML model based on the network configuration information and trajectory data indicating a trajectory of a movement of the first UE in the first group.

In some embodiments, the trajectory data indicates a minimum required throughput of the first UE and/or a QoS required for the first UE, and the minimum required throughput of the first UE and/or the QoS required for the first UE is associated with a certain geographical location within the trajectory of the movement of the first UE in the first group.

In some embodiments, the process 800 comprises, after receiving the first predicted network usage data, transmitting, to a second UE included in the first group, the first predicted network usage data; and receiving, from the second UE included in the first group, second predicted network usage data that indicates predicted network usage for the first UE and the second UE in the first group, wherein the second predicted network usage data is generated using the first ML model based on (i) the network configuration information and (ii) a trajectory of a movement of the second UE in the first group.

In some embodiments, the process 800 comprises receiving, from each UE included in the second group, ML model parameters of an ML model for encoding trajectory data that indicates a trajectory of a UE; combining the received ML model parameters, thereby generating a global ML model for encoding trajectory data that indicates a trajectory of a UE; and transmitting, to the second group of UEs, ML model parameters of the global ML model, wherein the first encoded trajectory data is generated at the first UE in the second group using the global ML model.

In some embodiments, the process 800 comprises obtaining network configuration information indicating a network configuration of one or more base stations associated with the network node; and providing (i) the obtained network configuration information and (ii) the first encoded trajectory data to a prediction ML model, thereby generating predicted network usage data that indicates predicted network usage for the first UE in the second group.

In some embodiments, the process 800 comprises receiving, from a second UE included in the second group of UEs, second encoded trajectory data that indicates a trajectory of the second UE in the second group, and providing (i) the obtained network configuration information, (ii) the second encoded trajectory data, and (iii) the predicted network usage data indicating the predicted network usage for the first UE in the second group to the prediction ML model, thereby generating updated predicted network usage data that indicates predicted network usage for the first UE and the second UE in the second group.

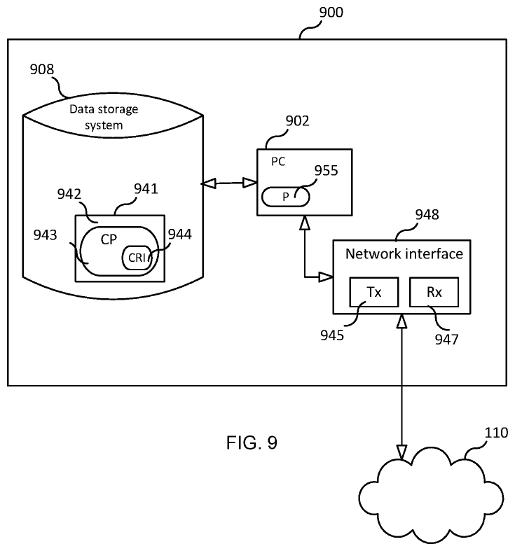

FIG. 9 is a block diagram of an apparatus 900, according to some embodiments, for implementing the controller 126. As shown in FIG. 9, apparatus 900 may comprise: processing circuitry (PC) 902, which may include one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); a network interface 948 comprising a transmitter (Tx) 945 and a receiver (Rx) 947 for enabling apparatus 900 to transmit data to and receive data from other nodes connected to a network 110 (e.g., an Internet Protocol (IP) network) to which network interface 948 is connected (directly or indirectly) (e.g., network interface 948 may be wirelessly connected to the network 110, in which case network interface 948 is connected to an antenna arrangement); and a local storage unit (a.k.a., “data storage system”) 908, which may include one or more non-volatile storage devices and/or one or more volatile storage devices. In embodiments where PC 902 includes a programmable processor, a computer program product (CPP) 941 may be provided. CPP 941 includes a computer readable medium (CRM) 942 storing a computer program (CP) 943 comprising computer readable instructions (CRI) 944. CRM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

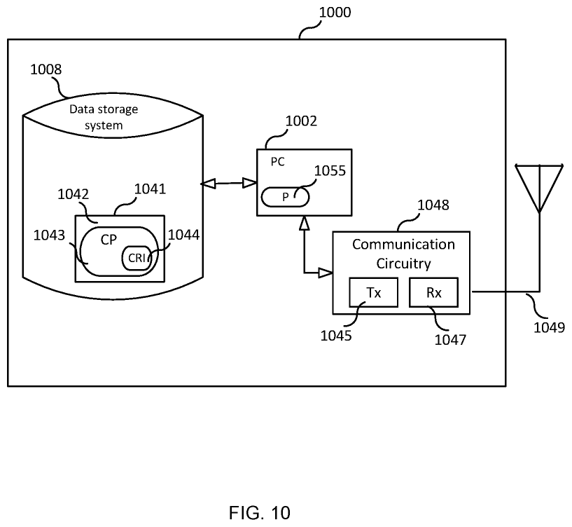

FIG. 10 is a block diagram of each of the UEs 102-116, according to some embodiments. As shown in FIG. 10, the UE may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like); communication circuitry 1048, which is coupled to an antenna arrangement 1049 comprising one or more antennas and which comprises a transmitter (Tx) 1045 and a receiver (Rx) 1047 for enabling UE 102 to transmit data and receive data (e.g., wirelessly transmit/receive data); and a local storage unit (a.k.a., “data storage system”) 1008, which may include one or more non-volatile storage devices and/or one or more volatile storage devices. In embodiments where PC 1002 includes a programmable processor, a computer program product (CPP) 1041 may be provided. CPP 1041 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes UE 102 to perform steps described herein (e.g., steps described herein with reference to the flow charts). In other embodiments, UE 102 may be configured to perform steps described herein without the need for code. That is, for example, PC 1002 may consist merely of one or more ASICs. Hence, the features of the embodiments described herein may be implemented in hardware and/or software.

### CONCLUSION

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first user equipment (UE), the method comprising:
obtaining a machine learning (ML) model for predicting network usage for a UE;
receiving, from a network node, network configuration information indicating a network configuration of a first base station;
generating trajectory data indicating a trajectory of the first UE's movement;
based on the trajectory data and the network configuration information, using the ML model, generating predicted network usage data indicating predicted network usage for the first UE; and
transmitting to the network node the predicted network usage data.

2. The method of claim 1, wherein
the predicted network usage for the first UE is predicted usage of physical resource blocks (PRBs) in a plurality of base stations due to communications between the first UE and the first UE's serving base station.

3. The method of claim 1, wherein
the ML model is configured to predict network usage for a UE based on any one or more of: a location of a UE, a minimum required throughput of a UE, a quality of service (QoS) required for a UE, a network configuration of a base station, and/or a current PRB utilization of a base station.

4. The method of claim 1, wherein
the trajectory data indicates a minimum required throughput of the first UE and/or a QoS required for the first UE, and
the minimum required throughput of the first UE and/or the QoS required for the first UE is associated with a certain geographical location within the trajectory of the first UE's movement.

5. The method of claim 1, wherein
a plurality of UEs connected to the network node are classified into a first group of one or more UEs and a second group of one or more UEs,
the classification of a UE is based on any one or more of: a trust level of a UE, a channel condition of a UE, computational capability of a UE, historical data associated with a UE, or a past behavior of a UE,
only UEs included in the first group of UEs are allowed to receive from the network node ML model information indicating the ML model, and
the first UE belongs to the first group of UEs.

6. A method performed by a first user equipment (UE), the method comprising:
obtaining a first machine learning (ML) model for generating encoded trajectory data associated with a trajectory of a UE's movement;
generating trajectory data indicating a trajectory of the first UE's movement;
based on the trajectory data, using the first ML model, generating encoded trajectory data indicating the trajectory of the first UE's movement; and
transmitting to a network node the encoded trajectory data for predicting network usage for the first UE.

7. The method of claim 6, wherein
predicted network usage for the first UE is predicted usage of physical resource blocks (PRB) in a plurality of base stations due to communications between the first UE and the first UE's serving base station.

8. The method of claim 6, wherein
the trajectory data indicates a minimum required throughput of the first UE and/or a quality of service, QoS, required for the first UE, and
the minimum required throughput of the first UE and/or the QoS required for the first UE is associated with a certain geographical location within the trajectory of the first UE's movement.

9. The method of claim 6, wherein
the method further comprises:
training an initial ML model for generating encoded trajectory data associated with a trajectory of a UE's movement;
transmitting to the network node the trained initial ML model; and
receiving from the network node a global ML model that is generated based on the trained initial ML model, and
the first ML model is the global ML model.

10. The method of claim 9, wherein
a plurality of UEs connected to the network node are classified into a first group of one or more UEs and a second group of one or more UEs,
the classification of a UE is based on: a trust level of a UE, a channel condition of a UE, computational capability of a UE, historical data associated with a UE, and/or a past behavior of a UE,
only UEs included in the second group of UEs are allowed to receive from the network node ML model information indicating the global ML model, and
the first UE belongs to the second group of UEs.

11. A method performed by a network node, the method comprising:
receiving, from a first user equipment (UE) included in a first group of UEs, first predicted network usage data that indicates predicted network usage for the first UE in the first group;
receiving, from a first UE (108 or 112) included in a second group of UEs, first encoded trajectory data that indicates a trajectory of the first UE in the second group; and
after receiving the first predicted network usage data and the first encoded trajectory data, generating combined predicted network usage data that indicates combined predicted network usage for the first group of UEs and the second group of UEs.

12. The method of claim 11, wherein
UEs are classified into the first group of UEs or the second group of UEs based on: a trust level of a UE, a channel condition of a UE, computational capability of a UE, historical data associated with a UE, and/or a past behavior of a UE.

13. The method of claim 11, wherein
the predicted network usage for the first UE in the first group is predicted usage of physical resource blocks (PRBs) in a plurality of base stations due to communications between the first UE in the first group and the first UE's serving base station.

14. The method of claim 11, wherein
the method further comprises transmitting, only to the first group of UEs, first ML model information indicating a first ML model for predicting network usage for a UE, and
the first predicted network usage data is generated using the first ML model.

15. The method of claim 14, wherein
the first ML model is configured to predict network usage for a UE based on any one or more of: a location of a UE, a minimum required throughput of a UE, a quality of service (QoS) required for a UE, a network configuration of a base station, and/or a current physical resource block, PRB, utilization of a base station.

16. The method of claim 14, comprising:
transmitting, to the first group of UEs, network configuration information indicating a network configuration of one or more base stations associated with the network node, wherein
the first predicted network usage data is generated using the first ML model based on the network configuration information and trajectory data indicating a trajectory of a movement of the first UE in the first group.

17. The method of claim 16, wherein
the trajectory data indicates a minimum required throughput of the first UE and/or a QoS required for the first UE, and
the minimum required throughput of the first UE and/or the QoS required for the first UE is associated with a certain geographical location within the trajectory of the movement of the first UE in the first group.

18. The method of claim 16, comprising:
after receiving the first predicted network usage data, transmitting, to a second UE included in the first group, the first predicted network usage data; and
receiving, from the second UE included in the first group, second predicted network usage data that indicates predicted network usage for the first UE and the second UE in the first group, wherein
the second predicted network usage data is generated using the first ML model based on (i) the network configuration information and (ii) a trajectory of a movement of the second UE in the first group.

19. The method of claim 11, comprising:
receiving, from each UE included in the second group, ML model parameters of an ML model for encoding trajectory data that indicates a trajectory of a UE;
combining the received ML model parameters, thereby generating a global ML model for encoding trajectory data that indicates a trajectory of a UE; and
transmitting, to the second group of UEs, ML model parameters of the global ML model, wherein
the first encoded trajectory data is generated at the first UE in the second group using the global ML model.

20. The method of claim 11, comprising:
obtaining network configuration information indicating a network configuration of one or more base stations associated with the network node; and
providing (i) the obtained network configuration information and (ii) the first encoded trajectory data to a prediction ML model, thereby generating predicted network usage data that indicates predicted network usage for the first UE in the second group.

21-27. (canceled)
